(19) United States
(12) Patent Application Publication
(10) Pub. No.: US 2026/0336196 A1
(43) Pub. Date: Oct. 29, 2026

(54) METHOD FOR AUTOMATICALLY DETERMINING THE ELECTRICAL ENERGY TO BE SUPPLIED TO A FURNACE FOR HEATING PREFORMS, ARRANGED UPSTREAM OF A STRETCH-BLOW MOLDING MACHINE

(71) Applicant: S.I.P.A. SOCIETA' INDUSTRIALIZZAZIONE PROGETTAZIONE E AUTOMAZIONE S.P.A., Vittorio Veneto (IT)

(72) Inventors: Paolo DE NARDI, Treviso (IT); David GAIOTTI, Susegana (IT); Livio VOLPATO, Sant'Angelo (IT); Matteo ZOPPAS, Conegliano (IT)

(21) Appl. No.: 19/107,241

(22) PCT Filed: Sep. 1, 2023
(86) PCT No.: PCT/IB2023/058668

§ 371 Date: Feb. 27, 2025

(30) Foreign Application Priority Data
Sep. 2, 2022 (IT) 102022000018045

(51) Int. Cl. B29C 49/64; B29C 49/78; F27D 19/00; H05B 3/00

(52) U.S. Cl. CPC B29C 49/6418; B29C 49/786; F27D 19/00; B29C 2049/7861; F27D 2019/0037; H05B 3/0057; H05B 2203/005; H05B 2203/032

(57) ABSTRACT

A method for automatically determining the electrical energy in kWh to be supplied to a furnace provided with a plurality of heating modules arranged in at least one bench upstream of a stretch-blow molding machine provided with a plurality of molding cavities for molding containers, in which each heating module is provided with a plurality of heating elements arranged along a plane substantially parallel to the plane containing the axes of the preforms advancing along the bench, the method comprising the following steps
a) providing the following parameters as input data:
   hourly productivity (v) of the molding machine;
   geometrical and weight data of the preform and preform neck;
   geometrical data of the container to be molded;
   number of heating modules;
   number of heating elements in each heating module;
b) providing a first range of total stretching ratio; a second range of total stretching ratio; and a third range of total stretching ratio;
c) providing a first curve y=a*x^{-b}, a second curve y=c*x^{-d}, and a third curve y=e*x^{-f}, where y is the specific power in W/g that the heating elements have to supply for each gram of net weight of the preform, and where x is the net weight of the preform in grams;
d) calculating the total stretching ratio by multiplying the axial stretching ratio by the radial stretching ratio;
e) extracting the value W/g from the first curve if the total stretching ratio calculated in step
d) falls in the first range, from the second curve if said total stretching ratio falls in the second range, or from the third curve if the total stretching ratio falls in the third range;
f) calculating the electrical energy in kWh required for said hourly productivity (v).

### FIELD OF THE INVENTION

The present invention relates to a method for automatically determining the electrical energy in kWh to be supplied to a furnace provided with a plurality of heating modules arranged in at least one bench upstream of a stretch-blow molding machine.

### BACKGROUND ART

It is known that the stretch-blowing process must be preceded by a temperature conditioning step of the preforms, in which the preforms are heated to a predefined temperature for the blowing by means of specific heating modules which use a plurality of heating elements, e.g., infrared lamps.

Generally, the heating modules are arranged symmetrically in two benches connected by a curved stretch. The heating elements in each module are arranged along a plane substantially parallel to the plane containing the axes of the preforms advancing along the respective bench.

During the passage of the preforms in these modules, the neck of the preforms must remain substantially cold, i.e., at a temperature lower than the softening temperature so that the successive blowing operations do not deform it.

It is also known that the heating of the body of the preforms is achieved due to the combined effect of:
thermal radiation which penetrates into the thickness of the body of the preform (convection);
contact with the ambient air heated inside the furnace (conduction);
diffusion of the heat by conduction into the wall of the preform (stabilization/temperature inversion).

It also is important to ventilate the inside of the heating module and the outer surface of the preforms therein with a preset air flow so that the material of the outer surface of the preform is not brought to a too high temperature, which would cause it to crystalize while waiting for the material arranged inside the preform to reach the blowing temperature.

This ventilation allows the ambient temperature of the heating module to be kept at a desirable level, eliminating the excessive heat, for example due to the infrared rays not captured by the preforms, and the temperature of the preform skin to be moderated. Such a desirable level of the inner temperature of the heating module is the one that allows the energy performance thereof to be optimized. It is well known that this energy performance is a function of the thickness of the preforms. The ventilation flow rate must be sufficient to perform this function, and it is desirable for it to be well-distributed in the heating module so that the whole surface of the preform wall, which must be heated, is treated homogeneously. Actually, it is still quite complex, in particular for operators with little experience, to optimally manage the heating elements of preforms in the heating modules arranged upstream of the stretch-blow molding machine according to the geometrical and weight data of the preform, the geometrical data of the container to be molded and the hourly productivity of the stretch-blow molding machine, expressed in containers per molding cavity per hour.

Known solutions exist which provide a feedback regulation of the electrical energy in kWh to be supplied to the heating elements of each module, said regulation being based on a control during the performance of the container production process. Disadvantageously, however, the production process proceeds prior to this feedback regulation, resulting in the arrival of not perfectly heated preforms at the stretch-blow molding machine.

In any case, a predictive-type method, which allows automatically determining the optimal electrical energy in kWh to be supplied to the heating modules according to a predefined hourly productivity of the molding machine which blow molds specific containers starting from a specific preform, is not known.

Therefore, the need is felt to provide an automated method of the predictive type.

### SUMMARY OF THE INVENTION

It is an object of the present invention to provide a predictive-type method for automatically determining, by means of computer, the optimal electrical energy in kWh to be supplied to the heating modules of a furnace arranged upstream of a stretch-blow molding machine having a predefined hourly productivity of a specific container blown from a specific preform. It is another object of the present invention to provide a predictive-type method for managing the heating elements of preforms in said heating modules.

It is another object of the present invention to provide a method which is also capable of automatically identifying the number of heating elements to be activated in each heating module.

It is a further object of the present invention to provide a predictive-type method for obtaining an optimal distribution of the electrical energy in kWh on the heating elements to be activated in each heating module.

The present invention achieves at least one of such objects and other objects that will be apparent in light of the present description by means of a method for automatically determining the electrical energy in kWh to be supplied to a furnace provided with a plurality of heating modules arranged in at least one bench upstream of a stretch-blow molding machine provided with a plurality of molding cavities for molding containers, wherein each heating module is provided with a plurality of heating elements arranged along a plane substantially parallel to the plane containing the axes of the preforms advancing along the bench, the method comprising the following steps
a) providing the following parameters as input data:
   hourly productivity v of the molding machine, expressed in containers per molding cavity per hour;
   geometrical and weight data of the preform and preform neck;
   geometrical data of the container to be molded;
   number of heating modules;
   number of heating elements in each heating module;
b) providing a first range of total stretching ratio; a second range of total stretching ratio comprising greater values than said first range; and a third range of total stretching ratio comprising greater values than said second range;
c) providing a first curve y=a*x^{-b}, a second curve y=c*x^{-d}, and a third curve y=e*x^{-f}, where y is the specific power or power-to-mass ratio in W/g defining the power that the heating elements have to absorb for each gram of net weight of the preform, wherein said net weight of the preform is equal to the weight of the preform less the weight of the preform neck, and where x is the net weight of the preform in grams;
d) calculating the total stretching ratio by multiplying the axial stretching ratio by the radial stretching ratio;
e) extracting the value W/g from the first curve if the total stretching ratio calculated in step
d) falls in the first range, from the second curve if said total stretching ratio falls in the second range, or from the third curve if the total stretching ratio falls in the third range;
f) calculating the electrical energy in kWh required for said hourly productivity v.

In a preferred variant, said first range of total stretching ratio comprises values less than or equal to 8; said second range of total stretching ratio comprises values greater than 8 and less than 13.5; and said third range of total stretching ratio comprises values greater than or equal to 13.5; while coefficient “a” has a value from 0.45 to 0.58; coefficient “b” has a value from −0.25 to −0.35; coefficient “c” has a value from 0.60 to 0.75; coefficient “d” has a value from −0.36 to −0.50; coefficient “e” has a value from 0.75 to 0.86; and coefficient “f” has a value from −0.54 to −0.60.

Advantageously, the method of the invention also allows a quick and effective parameterization of the industrial stretch-blow process in few minutes with the goal of obtaining a product at 80% of its conformity.

By carrying out this method, the testing times are considerably shortened also in the presence of operators with little experience, for whom statistically it is complex to perform the first part (80%) of the industrial stretch-blow process, but it is simpler and more effective to complete the remaining 20% of the industrial process according to a final adjustment criterion.

Further features and advantages of the invention will become more apparent in light of the detailed description of exemplary, but non-exclusive embodiments thereof.

The dependent claims describe particular embodiments of the invention.

### BRIEF DESCRIPTION OF THE DRAWINGS

In the description of the invention, reference is made to the accompanying drawings, which are provided by way of non-limiting example, in which:

FIG. 1 shows a diagrammatic layout of a heating module bench of a furnace arranged upstream of a molding machine;

FIG. 2 shows a diagrammatic sectional view of a heating module crossed by the preforms;

FIG. 3 diagrammatically shows an activation criterion of the heating elements close to the bottom of the preform;

FIG. 3a shows a variant indicating the last and second-last heating element to be activated in a heating module;

FIG. 4 shows a diagrammatic sectional view of a preform;

FIG. 5 shows a diagrammatic side view of a container blown from the preform in FIG. 4;

FIG. 6 shows a diagram with some input data for performing a method according to the invention;

FIG. 7 shows three trend curves of the specific power W/g according to the net weight of the preform in grams.

The same reference numerals and letters in the figures identify the same elements or components.

### DESCRIPTION OF EMBODIMENTS OF THE INVENTION

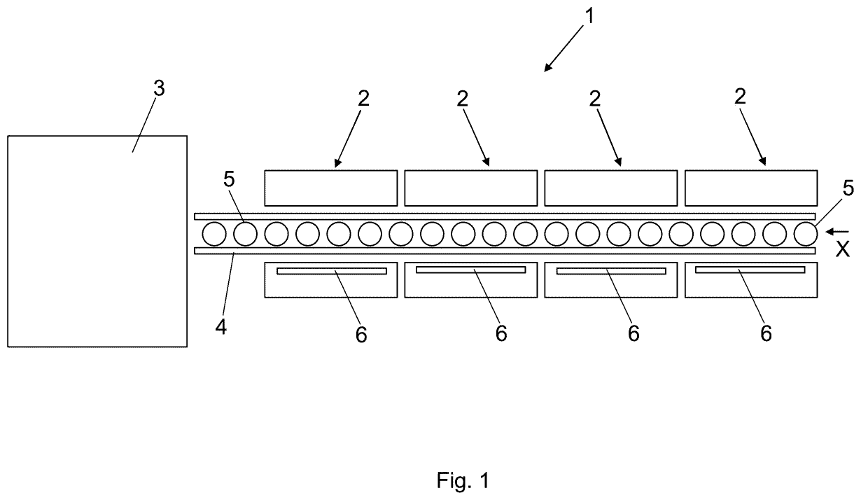

FIG. 1 shows a generic furnace, indicated by reference numeral 1, provided with a plurality of heating modules 2 arranged in a bench upstream of a stretch-blow molding machine 3 provided with a plurality of molding cavities (not shown) for molding containers.

Arrow X indicates the advancement direction of the preforms 5 crossing the respective heating modules 2.

Alternatively, the heating modules 2 can be arranged in at least two benches connected by a connection stretch, e.g., a curved or serpentine stretch.

The molding machine 3 can be a linear-type machine or a rotary machine.

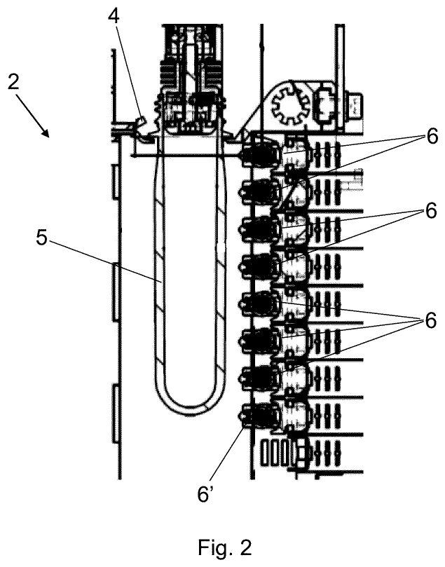

As better shown in FIG. 2, each heating module 2 is provided with a plurality of heating elements 6 arranged along a plane substantially parallel to the plane containing the axes of the preforms 5 advancing along the bench on a transport line 4, for example, provided with chucks.

The method of the present invention is a predictive method for automatically determining the optimal electrical energy in kWh for a predefined hourly productivity of a specific container blown from a specific preform.

Such a method advantageously comprises the following steps:
a) providing the following parameters as input data:
   hourly productivity v of the molding machine, expressed in containers per molding cavity per hour (containers/cavities per hour);
   geometrical and weight data of the preform and preform neck;
   geometrical data of the container to be molded;
   number of heating modules 2;
   number of heating elements in each heating module 2;
b) providing a first range of total stretching ratio; a second range of total stretching ratio comprising greater values than said first range; and a third range of total stretching ratio comprising greater values than said second range;
c) providing a first curve y=a*x^{-b}, a second curve y=c*x^{-d}, and a third curve y=e*x^{-f}, where y is the specific power or power-to-mass ratio in W/g defining the power that the heating elements have to absorb for each gram of net weight of the preform, wherein said net weight of the preform is equal to the weight of the preform minus the weight of the preform neck, and where x is the net weight of the preform in grams;
d) calculating the total stretching ratio by multiplying the axial stretching ratio by the radial stretching ratio;
e) extracting the value W/g from the first curve if the total stretching ratio calculated in step d) falls in the first range, from the second curve if said total stretching ratio falls in the second range, or from the third curve if the total stretching ratio falls in the third range;
f) calculating the electrical energy in kWh required for said hourly productivity v.

In step f), the electrical energy in kWh required for said hourly productivity v is equal to: (W/g*net weight of the preform*v*number of molding cavities)/1000,
where W/g is the value extracted in step e).

Surprisingly, after lengthy and complex technical considerations, the inventors discovered that by using predefined ranges of total stretching ratio and of coefficients a, b, c, d, e, f of the three curves of step c) in combination with each other, the technical effect of automatically predicting the optimal electrical energy in kWh for a predefined hourly productivity of a specific container blown from a specific preform is reached in a simple, quick and highly efficient manner while considerably reducing consumption. This prediction is also useful for then automatically identifying the number of heating elements to be activated in each heating module.

In a preferred, but not exclusive variant, the first range of total stretching ratio comprises values less than or equal to 8; the second range of total stretching ratio comprises values greater than 8 and less than 13.5; and the third range of total stretching ratio comprises values greater than or equal to 13.5; while coefficient “a” has a value from 0.45 to 0.58; coefficient “b” has a value from −0.25 to −0.35; coefficient “c” has a value from 0.60 to 0.75; coefficient “d” has a value from −0.36to −0.50; coefficient “e” has a value from 0.75 to 0.86; and coefficient “f” has a value from −0.54 to −0.60.

In a further variant of the invention, coefficient “a” has a value from 0.45 to 0.55; coefficient “b” has a value from −0.27to −0.35; coefficient “c” has a value from 0.60 to 0.72; coefficient “d” has a value from −0.40to −0.48; coefficient “e” has a value from 0.78 to 0.86; coefficient “f” has a value from −0.54 to −0.60.

Preferably, the method of the invention allows the number of heating elements to be activated in each heating module to be automatically identified.

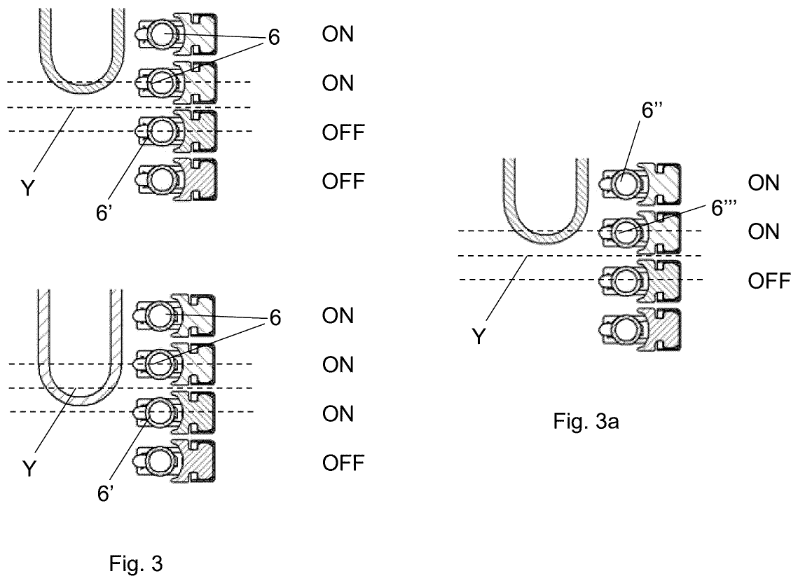

To obtain this result, after step f), the following steps are provided:
g) identifying the number of heating elements to be activated in each heating module (FIG. 3), always including all the heating elements 6 lying on a horizontal plane intersecting the body of the advancing preforms, and including the adjacent successive further heating element 6′ lying on a respective horizontal plane not intersecting the body of the preforms only in case, considering the center distance between the last of said heating elements 6 lying on a horizontal plane intersecting the body of the preforms and said successive further heating element 6′ proximal thereto, the height Y corresponding to the half-center distance of said center distance intersects the bottom of the preforms;
h) activating, in each heating module 2, the heating elements identified in step g) by distributing said electrical energy in kWh on said identified heating elements.

The last of the heating elements 6 lying on a horizontal plane intersecting the body of the preforms is the most distal one from the neck of the advancing preforms.

The successive further heating element 6′, lying on a respective horizontal plane not intersecting the body of the preforms, is arranged below the last of said heating elements 6 lying on a horizontal plane intersecting the body of the preforms in case the transport line is configured to advance the preforms with the opening of the neck facing upwards, as shown in FIGS. 2 and 3.

Alternatively, it is not excluded for the successive further heating element 6′ to be arranged above said last heating element 6 in case the transport line is configured to advance the preforms with the opening of the neck facing downwards.

FIG. 3 diagrammatically shows the criterion for identifying the heating elements to be activated according to the length of the preform (step g). The term “ON” indicates the heating elements to be activated, while the term “OFF” indicates the heating elements which remain switched off.

In all the embodiments of the invention, the heating elements 6, 6′ can be infrared lamps arranged along a plane substantially parallel to said plane containing the axes of the preforms crossing the heating module. As an alternative to the infrared lamps, LED, NIR or laser lamps can be used, or another suitable heating element.

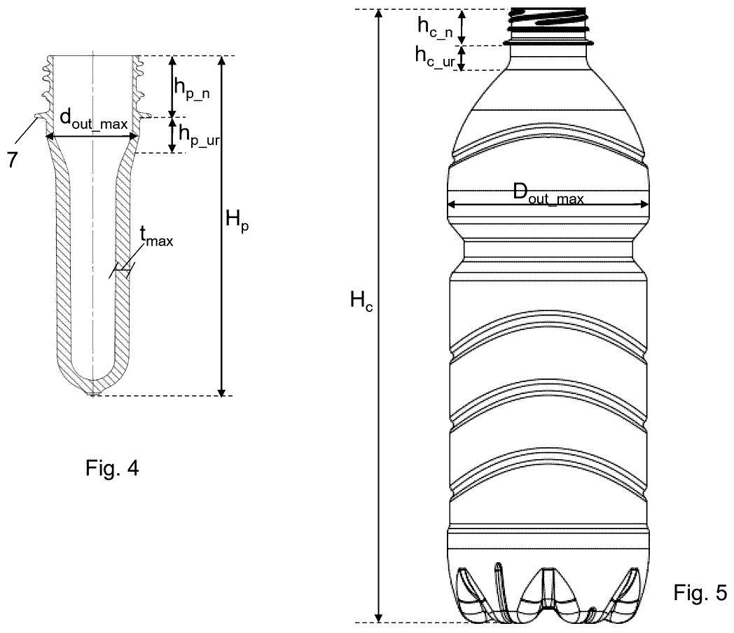

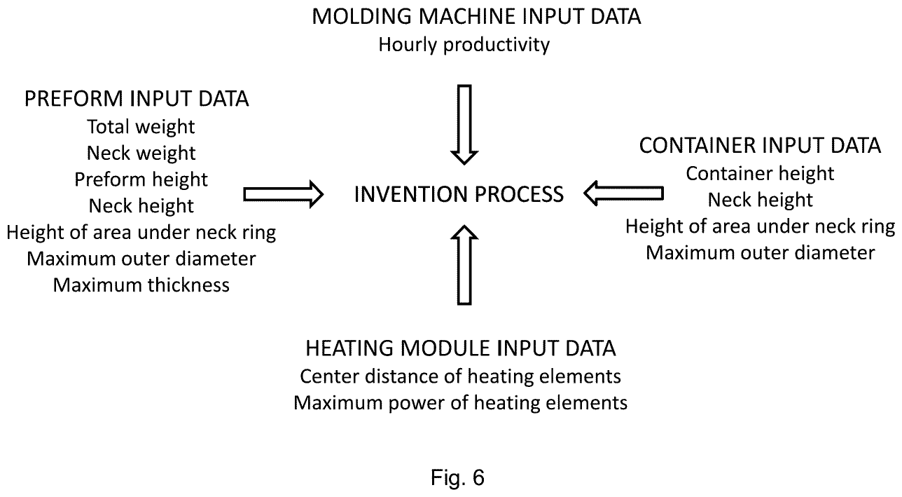

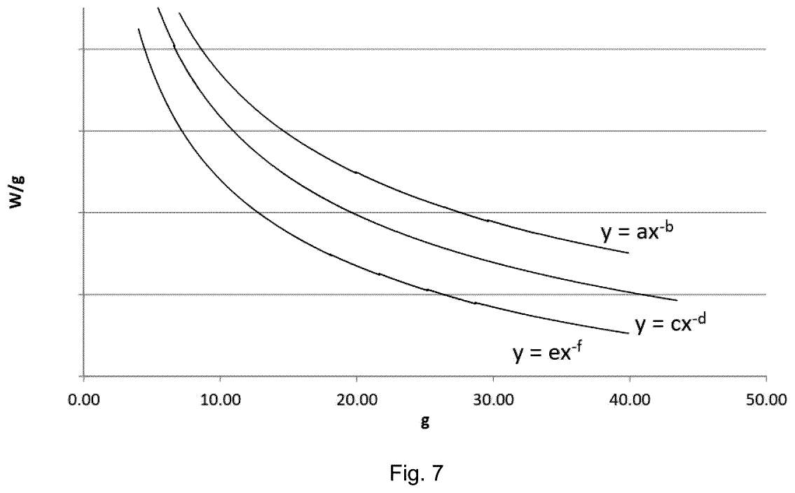

FIGS. 4 and 5 respectively show an example of preform and container obtained by stretch-blow molding. These figures indicate geometrical data examples of the preform and container to be molded that are used by the method of the invention:
Hₚ=height of the preform,
h_{p_n}=height of the preform neck,
h_{p_ur}=height of the preform area under neck ring,
d_{out_max}=maximum outer diameter of the preform,
tₘₐₓ=maximum thickness of the preform,
H_{c}=height of the container,
h_{c_n}=height of the container neck,
h_{c_ur}=height of the container area under neck ring,
D_{out_max}=maximum outer diameter of the container.

As known in the field, the term “area under neck ring” means the area immediately below the support ring 7 where there remains a greater thickness of the container due to the unstretched material after the blowing.

Considering these geometrical data, the radial stretching ratio is calculated with the following ratio
D_{out_max}/(d_{out_max}−tₘₐₓ),
while the axial stretching ratio is calculated with the following ratio
(H_{c}−h_{c_n}−h_{c_ur})/(Hₚ−h_{p_n}−h_{p_ur}).

Further input data can further comprise:
the center distance of the heating elements, preferably equal in each heating module;
the maximum power of the heating elements, preferably equal in each heating module.

Preferably, in step h), the distribution of the electrical energy in kWh on the identified heating elements 6, 6′ is performed according to a first profile in case also the further heating element 6′ lying on a respective horizontal plane not intersecting the body of the preforms is to be activated, or, is performed according to a second profile in case also said further heating element 6′ is not to be activated. “Profile” means the distribution trend of the electrical energy in kWh on the identified heating elements 6, 6′ along a direction parallel to the axes of the preforms 5 advancing along the bench.

More in detail, with the transport line configured to advance the preforms with the opening of the neck facing upwards as shown in FIGS. 2-3a, in case also said further heating element 6′ is to be activated, an optimal and automated distribution of the electrical energy in kWh on the identified heating elements 6, 6′ is determined in the following manner:
A being defined as the electrical energy in kWh, calculated in step f), divided by the number of identified heating elements 6, 6′ in all the plurality of heating modules 2,
n being defined as the number of identified heating elements 6, 6′ in each heating module 2, in each heating module 2
   for the upper identified heating element, arranged in position most proximal to the support ring 7 of the advancing preforms, the electrical energy to be supplied is equal to

A₁=A+x*A,
where coefficient x varies in a range from 1/9 to ¾;
   while for the remaining identified heating elements, the electrical energy to be supplied is equal to

Aᵢ=[(A*n)−A₁]/(n−1).

Instead, in case also said further heating element 6′ is not to be activated, an optimal and automated distribution of the electrical energy in kWh on the identified heating elements 6 is determined in the following manner:
A being defined as the electrical energy in kWh, calculated in step f), divided by the number of identified heating elements 6 in all the plurality of heating modules 2,
n being defined as the number of identified heating elements 6 in each heating module 2, in each heating module 2
   for the upper identified heating element, arranged in position most proximal to the support ring 7 of the advancing preforms, the electrical energy to be supplied is equal to

A₁=A+x*A,
where coefficient x varies in a range from 1/9 to ¾;
   for the identified heating elements arranged in an intermediate position between said upper identified heating element and the underlying second-last identified heating element 6″ (FIG. 3a), the electrical energy to be supplied is equal to

Aᵢ=[(A*n)−A+]/(n−1),
for said second-last identified heating element 6″, the electrical energy to be supplied is equal to

Aₙ₋₁=Aᵢ+x*Aᵢ,
and for the last identified heating element 6″, or lower identified heating element, arranged in position proximal to the bottom of the advancing preforms, the electrical energy to be supplied is equal to

Aₙ₋₁=Aᵢ−x*Aᵢ.

Instead, with the transport line configured to advance the preforms with the opening of the neck facing downwards (solution not shown), in case also said further heating element 6′ is to be activated, an optimal and automated distribution of the electrical energy in kWh on the identified heating elements 6, 6′ is determined in the following manner:
A being defined as the electrical energy in kWh, calculated in step f), divided by the number of identified heating elements 6, 6′ in all the plurality of heating modules 2,
n being defined as the number of identified heating elements 6, 6′ in each heating module 2, in each heating module 2
   for the lower identified heating element, arranged in position most proximal to the support ring 7 of the advancing preforms, the electrical energy to be supplied is equal to

A₁=A+x*A,
where coefficient x varies in a range from 1/9 to ¾;
   while for the remaining identified heating elements, the electrical energy to be supplied is equal to

Aᵢ=[(A*n)−A+]/(n−1).

Instead, in case also said further heating element 6′ is not to be activated, an optimal and automated distribution of the electrical energy in kWh on the identified heating elements 6 is determined in the following manner:
A being defined as the electrical energy in kWh, calculated in step f), divided by the number of identified heating elements 6 in all the plurality of heating modules 2,
n being defined as the number of identified heating elements 6 in each heating module 2, in each heating module 2
   for the lower identified heating element, arranged in position most proximal to the support ring 7 of the advancing preforms, the electrical energy to be supplied is equal to

A₁=A+x*A,
where coefficient x varies in a range from 1/9 to ¾;
for the identified heating elements arranged in an intermediate position between said lower identified heating element and the overlying second-last identified heating element 6″ (FIG. 3a), the electrical energy to be supplied is equal to

Aᵢ=[(A*n)−A₁]/(n−1),
for said second-last identified heating element 6″, the electrical energy to be supplied is equal to

Aₙ₋₁=Aᵢ+x*Aᵢ,
and for the last identified heating element 6″, or upper identified heating element, arranged in position proximal to the bottom of the advancing preforms, the electrical energy to be supplied is equal to

Aₙ₋₁=Aᵢ−x*Aᵢ.

Therefore, with the method according to the invention, quickly determining an optimal distribution of the electrical energy in kWh on the identified heating elements that must be activated in each heating module 2 is also possible in automated manner.

1. A method for automatically determining electrical energy in kWh to be supplied to a furnace provided with a plurality of heating modules arranged in at least one bench upstream of a stretch-blow molding machine provided with a plurality of molding cavities for molding containers, wherein each heating module is provided with a plurality of heating elements arranged along a first plane substantially parallel to a second plane containing axes of preforms advancing along the bench, the method comprising the following steps
a) providing the following parameters as input data:
hourly productivity v of the stretch-blow molding machine, expressed in containers per molding cavity per hour;
geometrical and weight data of the preform and preform neck;
geometrical data of the container to be molded;
number of the heating modules;
number of the heating elements in each heating module;
b) providing a first range of total stretching ratio; a second range of total stretching ratio comprising greater values than said first range; and a third range of total stretching ratio comprising greater values than said second range;
c) providing a first curve y=a*x^{-b}, a second curve y=c*x^{-d}, and a third curve y=e*x^{-f}, wherein y is a specific power or power-to-mass ratio in W/g defining a power that the heating elements (6) have to absorb for each gram of net weight of the preform, wherein said net weight of the preform is equal to weight of the preform minus weight of the preform neck, and where x is the net weight of the preform in grams;
d) calculating the total stretching ratio by multiplying axial stretching ratio by radial stretching ratio;
e) extracting a value W/g from the first curve if the total stretching ratio calculated in step d) falls in the first range, from the second curve if said total stretching ratio falls in the second range, or from the third curve if the total stretching ratio falls in the third range;
f) calculating the electrical energy in kWh required for said hourly productivity v.

2. The method according to claim 1, wherein said first range of total stretching ratio comprises values less than or equal to 8; said second range of total stretching ratio comprises values greater than 8 and less than 13.5; and said third range of total stretching ratio comprises values greater than or equal to 13.5;
and wherein coefficient “a” has a value from 0.45 to 0.58; coefficient “b” has a value from −0.25 to −0.35 ; coefficient “c” has a value from 0.60 to 0.75; coefficient “d” has a value from −0.36 to −0.50; coefficient “e” has a value from 0.75 to 0.86; coefficient “f” has a value from −0.54 to −0.60;
preferably wherein the electrical energy in kWh required for said hourly productivity v is equal to:
(W/g*net weight of the preform*v* number of molding cavities)/1000,
where W/g is the value extracted in step e).

3. The method according to claim 1, wherein after step f), the following steps for managing said heating elements are provided:
g) identifying the number of heating elements to be activated in each heating module, always including all the heating elements lying on a horizontal plane intersecting a body of the preforms, and including an adjacent successive further heating element lying on a respective horizontal plane not intersecting the body of the preforms only in case, considering a center distance between the last of said heating elements lying on a horizontal plane intersecting the body of the preforms and said further heating element proximal thereto, a height corresponding to a half-center distance of said center distance intersects a bottom of the preforms;
h) activating, in each heating module, the heating elements identified in step g) by distributing said electrical energy in kWh on the identified heating elements.

4. The method according to claim 2, wherein coefficient “a” has a value from 0.45 to 0.55; coefficient “b” has a value from −0.27to −0.35; coefficient “c” has a value from 0.60 to 0.72; coefficient “d” has a value from −0.40to −0.48; coefficient “e” has a value from 0.78 to 0.86; coefficient “f” has a value from −0.54to −0.60 .

5. The method according to claim 3, wherein in step h), a distribution of the electrical energy in kWh on said identified heating elements is performed according to a first profile in case also said further heating element lying on a respective horizontal plane not intersecting the body of the preforms is to be activated, or it is performed according to a second profile in case also said further heating element is not to be activated.

6. The method according to claim 3, wherein in case also said further heating element is to be activated, a distribution of the electrical energy in kWh on said identified heating elements is determined in the following manner:
A being defined as the electrical energy in kWh divided by the number of identified heating elements in said plurality of heating modules,
n being defined as the number of identified heating elements in each heating module,
in each heating module
for the identified heating element most proximal to a support ring of the preforms, the electrical energy to be supplied is equal to
A₁=A+x*A,
where coefficient x varies in a range from 1/9 to ¾;
for the remaining identified heating elements, the electrical energy to be supplied is equal to
Aᵢ=[(A*n)−A₁]/(n−1).

7. The method according to claim 3, wherein in case also said further heating element is not to be activated, a distribution of the electrical energy in kWh on said identified heating elements is determined in the following manner:
A being defined as the electrical energy in kWh divided by the number of identified heating elements in said plurality of heating modules,
n being defined as the number of identified heating elements in each heating module,
in each heating module
for the identified heating element most proximal to a support ring of the preforms, the electrical energy to be supplied is equal to
A₁=A+x*A,
where coefficient x varies in a range from 1/9 to ¾;
for the identified heating elements arranged in an intermediate position between said identified heating element most proximal to the support ring and the underlying, or overlying, second-last identified heating element, the electrical energy to be supplied is equal to
Aᵢ=[(A*n)−A₁]/(n−1),
for said second-last identified heating element, the electrical energy to be supplied is equal to
Aₙ₋₁=Aᵢ+x*Aᵢ,
and for the last identified heating element, or lower identified heating element or upper identified heating element, arranged in position proximal to the bottom of the preforms, the electrical energy to be supplied is equal to
Aₙ₋₁=Aᵢ−x*Aᵢ.

8. A The method according to claim 1, wherein the axial stretching ratio is calculated with the following ratio
(H_{c}−h_{c_n}−h_{c_ur})/(Hₚ−h_{p_n}−h_{p_ur}), where
H_{c}=height of the container,
h_{c_n}=height of the container neck,
h_{c_ur}=height of the container area under neck ring,
Hₚ=height of the preform,
h_{p_n}=height of the preform neck,
h_{p_ur}=height of the preform area under neck ring,
while the radial stretching ratio is calculated with the following ratio
D_{out_max}/(d_{out_max}−tₘₐₓ), where
D_{out_max}=maximum outer diameter of the container,
d_{out_max}=maximum outer diameter of the preform,
tₘₐₓ=maximum thickness of the preform.

9. The method according to claim 1, wherein the heating elements in each heating module are infrared lamps or NIR lamps or LED lamps or laser lamps.

10. The method according to claim 1, wherein said geometrical data of the preform comprise
height of the preform,
height of the neck,
height of the area under neck ring,
maximum outer diameter,
maximum thickness;
and wherein said geometrical data of the container to be molded comprise
height of the container,
height of the neck,
height of the area under neck ring,
maximum outer diameter.

11. The method according to claim 1, wherein said input data further comprise
center distance of the heating elements, preferably equal in each heating module;
maximum power of the heating elements, preferably equal in each heating module
